(19) United States
(12) Patent Application Publication
(10) Pub. No.: US 2024/0074502 A1
(43) Pub. Date: Mar. 7, 2024

(54) ELECTRONIC VAPORIZATION DEVICE AND VAPORIZER THEREOF

(71) Applicant: Shenzhen Verdewell Technology Limited, Shenzhen (CN)

(72) Inventor: Guoliang OU, Shenzhen (CN)

(21) Appl. No.: 18/461,230

(22) Filed: Sep. 5, 2023

(30) Foreign Application Priority Data
Sep. 7, 2022 (CN) 202222380637.0

(51) Int. Cl. A24F 40/46; A24F 40/48; H05B 3/46

(52) U.S. Cl. CPC A24F 40/46; A24F 40/48; H05B 3/46; H05B 2203/016

(57) ABSTRACT

A vaporizer includes: a vent tube having a conductive end surface; a vaporization core accommodated in the vent tube, the vaporization core including an end surface electrode; and an elastic conductive member accommodated in the vent tube, the elastic conductive member being arranged between the conductive end surface and the end surface electrode, and abutting against the conductive end surface and the end surface electrode.

### CROSS-REFERENCE TO PRIOR APPLICATION

Priority is claimed to Chinese Patent Application No. 202222380637.0, filed on Sep. 7, 2022, the entire disclosure of which is hereby incorporated by reference herein.

### FIELD

The present application relates to the field of vaporization, and more specifically, to an electronic vaporization device and a vaporizer thereof.

### BACKGROUND

The electronic vaporization device is configured to heat and vaporize a vaporizable liquid substrate to generate an inhalable aerosol. For the electronic vaporization devices in related technologies, a vaporization core is usually made of porous ceramics. The lead wire of such a porous ceramic vaporization core usually needs to penetrate through the porous ceramics, causing changes in the internal structure of the porous ceramics and easily leading to cracks. In addition, when wiring electrodes of the lead wire, the circuit wiring is long, and the manufacturing difficulty and production costs of the electronic vaporization devices are increased.

### SUMMARY

In an embodiment, the present invention provides a vaporizer, comprising: a vent tube comprising a conductive end surface; a vaporization core accommodated in the vent tube, the vaporization core comprising an end surface electrode; and an elastic conductive member accommodated in the vent tube, the elastic conductive member being arranged between the conductive end surface and the end surface electrode, and abutting against the conductive end surface and the end surface electrode.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic three-dimensional structural view of an electronic vaporization device in the first embodiment of the present application;

FIG. 2 is a schematic exploded structural view of the electronic vaporization device shown in FIG. 1;

FIG. 3 is a schematic cross-sectional view along the longitudinal direction of the vaporizer in FIG. 2;

FIG. 4 is a schematic cross-sectional exploded structural view along the longitudinal direction of the vaporizer shown in FIG. 3;

FIG. 5 is a schematic exploded structural view of a main body for liquid storage and vaporization in FIG. 4;

FIG. 6 is a schematic exploded structural view of the vaporization assembly in FIG. 4;

FIG. 7 is a schematic cross-sectional view along the longitudinal direction of a vaporizer in the second embodiment of the present application; and

FIG. 8 is a schematic exploded structural view of the vaporization assembly in FIG. 7.

### DETAILED DESCRIPTION

In an embodiment, the present invention provides an improved vaporizer and an electronic vaporization device having the vaporizer for the foregoing defects in the related art.

In an embodiment, the present invention provides a vaporizer, including:

a vent tube, where the vent tube includes a conductive end surface;

a vaporization core accommodated in the vent tube, where the vaporization core includes an end surface electrode; and an elastic conductive member accommodated in the vent tube, where

the elastic conductive member is arranged between the conductive end surface and the end surface electrode, and abuts against the conductive end surface and the end surface electrode for conduction.

In some embodiments, the vaporization core includes a porous ceramic and at least one heating track in contact with the porous ceramic; and the end surface electrode is arranged on the end surface of one end of the porous ceramic that is close to the conductive end surface, and is connected to one end of the at least one heating track.

In some embodiments, the porous ceramic is in the shape of cylinder, and the at least one heating track is arranged on the inner wall surface of the porous ceramic.

In some embodiments, the vent tube includes a first tube section and a second tube section connected to one end of the first tube section, the vaporization core is accommodated in the second tube section, and the end surface of one end of the second tube section that is close to the first tube section forms the conductive end surface.

In some embodiments, the inner diameter and the outer diameter of the second tube section are respectively greater than the inner diameter and the outer diameter of the first tube section.

In some embodiments, the elastic conductive member includes a main body portion, where the main body portion is in the shape of annular sheet and is arranged between the conductive end surface and the end surface electrode, and the end surfaces of two ends of the main body portion respectively abut against the conductive end surface and the end surface electrode for conduction.

In some embodiments, the elastic conductive member further includes at least two elastic arms connected to the main body portion, and the at least two elastic arms are evenly spaced along the circumferential direction of the main body portion.

In some embodiments, the at least two elastic arms are integrally connected to an outer edge of the main body portion.

In some embodiments, the conductive end surface and the inner wall surface of the second tube section are in a transition connection through an arc surface, the at least two elastic arms are in the shape of arc sheet, and the at least two elastic arms elastically abut against the arc surface for conduction.

In some embodiments, the elastic conductive member includes a main body portion and at least one elastic arm connected to the main body portion, where the main body portion abuts against one of the conductive end surface and the end surface electrode for conduction, and the at least one elastic arm elastically abuts against the other of the conductive end surface and the end surface electrode for conduction.

In some embodiments, the vaporizer further includes a base, and one end of the vent tube is embedded in the base and is in contact with the base for conduction.

The present application further provides an electronic vaporization device, including the vaporizer according to any one of the above.

Implementing the present application brings at least the following beneficial effects: The end surface electrode of the vaporization core is connected to the conductive end surface of the vent tube through the elastic conductive member, so that the end surface electrode may be in a better contact with the conductive end surface, and additionally it can be ensured that when the product consistency is poor, a reliable electrical connection can be still formed between the end surface electrode and the conductive end surface.

In order to have a clearer understanding of the technical features, the objectives, and the effects of the present application, specific implementations of the present application are now illustrated in detail with reference to the accompanying drawings. In the following description, many specific details are described for thorough understanding of the present application. However, the present application may be implemented in many other manners different from those described herein. A person skilled in the art may make similar improvements without departing from the connotation of the present application. Therefore, the present application is not limited to the specific embodiments disclosed below.

In the description of the present application, it should be understood that, orientation or position relationships indicated by terms such as “longitudinal”, “lateral”, “width”, “thickness”, “front”, “rear”, “upper”, “lower”, “left”, “right”, “top”, “bottom”, “inner”, and “outer” are orientation or position relationships shown based on the accompanying drawings or orientation or position relationships that the product of the present application is usually placed in use, and are merely used for describing the present application and simplifying the description, rather than indicating or implying that the mentioned apparatus or element should have a particular orientation or be constructed and operated in a particular orientation, and therefore, should not be construed as a limitation to the present application.

In addition, the terms “first” and “second” are merely used for descriptive purposes and are not to be construed as indicating or implying relative importance or implicitly indicating the number of technical features indicated. Therefore, a feature restricted by “first” or “second” may explicitly indicate or implicitly include at least one of such features. In the description of the present application, unless otherwise explicitly defined, “a plurality of” means at least two, for example, two, three, and the like.

In the present application, unless otherwise explicitly specified and defined, terms such as “mounted”, “connected”, “connection”, and “fixed” should be understood in a broad sense. For example, the connection may be a fixed connection, a detachable connection, or an integral connection; or the connection may be a mechanical connection or an electrical connection; or the connection may be a direct connection, an indirect connection through an intermediate medium, or internal communication between two elements or a mutual action relationship between two elements, unless otherwise explicitly specified. A person of ordinary skill in the art may understand the specific meanings of the foregoing terms in the present application according to specific situations.

In the present application, unless otherwise explicitly specified and defined, a first feature “on” or “below” a second feature may mean that the first feature and the second feature are in direct contact, or the first feature and the second feature are in indirect contact through an intermediary. Moreover, that the first feature is “above” the second feature may be that the first feature is right above the second feature or at an inclined top of the second feature, or may merely indicate that the horizontal height of the first feature is higher than that of the second feature. That the first feature is “below” the second feature may indicate that the first feature is directly below or obliquely below the second feature, or may merely indicate that the horizontal height of the first feature is lower than that of the second feature.

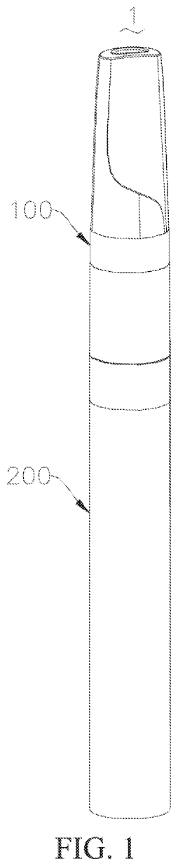

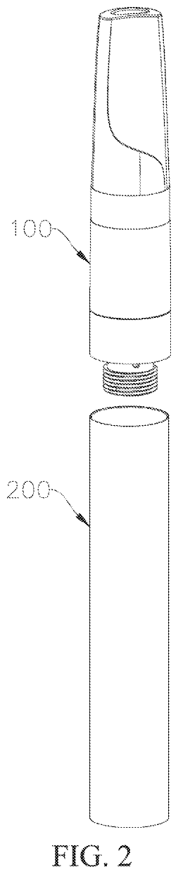

FIG. 1 and FIG. 2 show an electronic vaporization device 1 according to the first embodiment of the present application. The electronic vaporization device 1 includes a vaporizer 100 and a power supply device 200 in a fit connection to the vaporizer 100. The power supply device 200 is configured to supply power to the vaporizer 100 and control operations such as enabling and disabling of the entire electronic vaporization device 1. The vaporizer 100 is configured to accommodate a liquid substrate and heat and vaporize the liquid substrate after being energized to generate an aerosol. In some embodiments, both the vaporizer 100 and the power supply device 200 may substantially be in the shape of cylinder, and the vaporizer 100 may be mechanically and electrically connected to the power supply device 200 along the axial direction. Further, the vaporizer 100 may be detachably connected to the power supply device 200 in a threaded connection manner. It may be understood that, in another embodiment, the vaporizer 100 may alternatively be connected to the power supply device 200 in another detachable manner such as a magnetic connection or a buckle connection, or the vaporizer 100 may be connected to the power supply device 200 in an undetachable manner. In addition, the cross-sectional shapes of the vaporizer 100 and the power supply device 200 are not limited to the circular shape, and may alternatively be in the shape of ellipse, racetrack, rectangle, or other shapes.

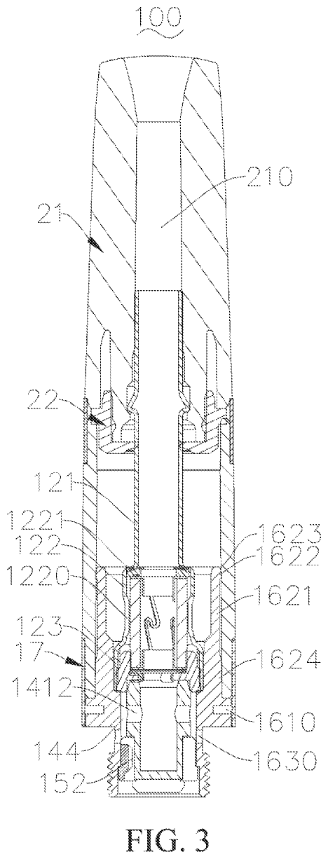

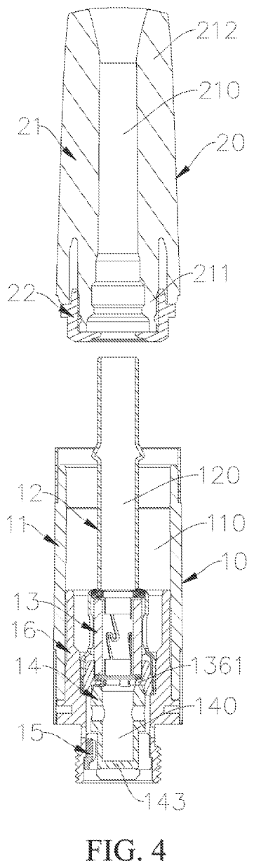

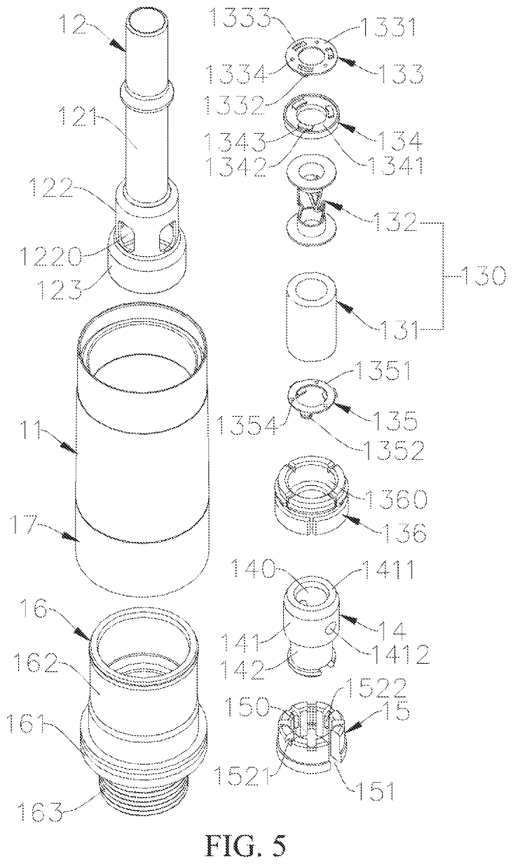

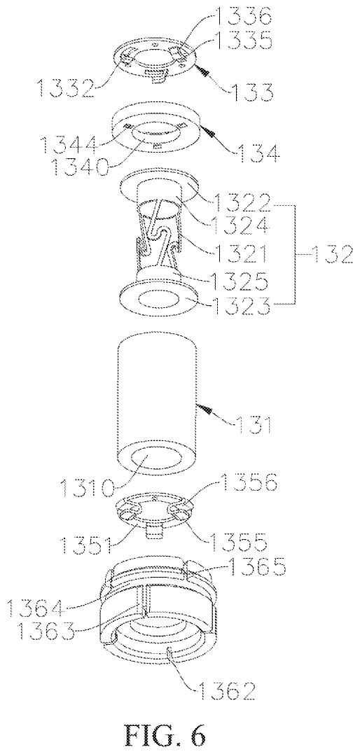

As shown in FIG. 3 to FIG. 6, the vaporizer 100 may include a main body 10 for liquid storage and vaporization and a suction nozzle main body 20 arranged at the upper end of the main body 10 for liquid storage and vaporization. A liquid storage cavity 110 for accommodating the liquid substrate and an output channel 120 for conveying the aerosol that is separate from the liquid storage cavity 110 are formed inside the main body 10 for liquid storage and vaporization. The suction nozzle main body 20 blocks the upper end of the liquid storage cavity 110, and an inhalation channel 210 in communication with the output channel 120 is formed inside the suction nozzle main body 20.

Specifically, the suction nozzle main body 20 may include a suction nozzle 21, and the inhalation channel 210 is formed inside the suction nozzle 21 along the longitudinal direction and may be coaxially arranged with the suction nozzle 21. In some embodiments, the suction nozzle 21 may be made of a hard material such as plastic cement, which is conducive to structural stability of the inhalation channel 210. Further, the suction nozzle 21 may include a blocking portion 211 at a lower portion and a suction nozzle portion 212 at an upper portion. The suction nozzle portion 212 may be in the flat shape, the flat design can better fit lips, and smoke can be more concentrated, thereby improving suction experience. The blocking portion 211 is embedded in an opening of the upper end of the main body 10 for liquid storage and vaporization, to seal and block the upper end of the liquid storage cavity 110. In some embodiments, the suction nozzle main body 20 may further include a seal member 22 sleeved outside the blocking portion 211.

The seal member 22 may be made of an elastic material such as silicone, and the seal member 22 is hermetically arranged between the outer wall surface of the blocking portion 211 and the cavity wall surface of the upper end of the liquid storage cavity 110.

In some embodiments, the suction nozzle main body 20 may be connected to the upper end of the main body 10 for liquid storage and vaporization in a detachable manner. On one hand, the liquid substrate can be added into the liquid storage cavity 110 by detaching the suction nozzle main body 20 from the main body 10 for liquid storage and vaporization, so that a service life of the vaporizer 100 is prolonged. On the other hand, components of the suction nozzle main body 20 and/or the main body 10 for liquid storage and vaporization can be separately replaced, thereby reducing costs. In another embodiment, the suction nozzle main body 20 may alternatively be connected to the main body 10 for liquid storage and vaporization in an undetachable manner.

The main body 10 for liquid storage and vaporization may include a shell 11, a vent tube 12, a vaporization assembly 13, an electrode column 14, and a base 16. The vent tube 12 is arranged inside the shell 11 along the longitudinal direction and may be coaxially arranged with the shell 11. The vent tube 12 may be in the shape of circular tube, the inner wall surface of the vent tube 12 defines the output channel 120, and the annular liquid storage cavity 110 is defined between the outer wall surface of the vent tube 12 and the inner wall surface of the shell 11. The upper end of the vent tube 12 may be embedded in the suction nozzle main body 20. Specifically, the upper end of the vent tube 12 may penetrate through the seal member 22 and be embedded in the suction nozzle 21. The seal member 22 is configured to hermetically wrap the vent tube 12, and the suction nozzle 21 is configured to ensure reliability of a connection between the vent tube 12 and the suction nozzle main body 20.

The vaporization assembly 13 is accommodated in the vent tube 12 and may be coaxially arranged with the vent tube 12. The vaporization assembly 13 includes a vaporization core 130, and the vaporization core 130 includes a liquid absorbing body 131 and a heating body 132 in contact with the liquid absorbing body 131. The liquid absorbing body 131 is in liquid communication with the liquid storage cavity 110, and is configured to absorb the liquid substrate from the liquid storage cavity 110 and convey the liquid substrate to the heating body 132. Specifically, in this embodiment, the liquid absorbing body 131 is a porous ceramic, which can absorb the liquid substrate from the liquid storage cavity 110 through impregnation and a capillary effect of microporous structures in the porous ceramic. The liquid absorbing body 131 may be in the shape of cylinder, and a vaporization cavity 1310 is formed through the liquid absorbing body 131 along the longitudinal direction. The vaporization cavity 1310 is in communication with the lower end of the output channel 120 and may be coaxially arranged with the output channel 120.

It may be understood that, in another embodiment, the liquid absorbing body 131 is not limited to the porous ceramics material, and may be made of other porous materials.

The heating body 132 may be a heating film, which may be formed on a blank of the liquid absorbing body 131 by silk-screen printing, printing, plating, or the like, and then integrally formed with the liquid absorbing body 131 by sintering. Alternatively, the heating body 132 may be a separately formed metal heating sheet or metal heating wire. The heating body 132 includes at least one heating track 1321 and two end surface electrodes 1322 and 1323 that are connected to two poles of the at least one heating track 1321. The at least one heating track 1321 may be arranged on the inner wall surface of the liquid absorbing body 131, and is configured to emit heat after being energized, to heat and vaporize the liquid substrate absorbed by the liquid absorbing body 131. The two end surface electrodes 1322 and 1323 are respectively arranged on the upper end surface and the lower end surface of the liquid absorbing body 131, and are configured to externally connect to an external power supply. Further, in some embodiments, the heating body 132 may further include two connection electrodes 1324 and 1325. The two connection electrodes 1324 and 1325 are respectively arranged at the upper end and the lower end of the inner wall surface of the liquid absorbing body 131, and the upper end and the lower end of the heating track 1321 are respectively connected to the two end surface electrodes 1322 and 1323 through the two connection electrodes 1324 and 1325. It may be understood that, in another embodiment, the heating body 132 may alternatively not include the two connection electrodes 1324 and 1325, that is, the upper end and the lower end of the heating track 1321 may be directly connected to the two end surface electrodes 1322 and 1323.

In this embodiment, the heating body 132 includes three heating tracks 1321 that are connected in parallel, and the three heating tracks 1321 are evenly spaced along the circumferential direction of the liquid absorbing body 131, which is conducive to evenly heat the liquid substrate absorbed by the liquid absorbing body 131. Each heating track 1321 extends in a non-linear manner along the axial direction of the heating body 132, such as extending in a curved or broken line, which is conducive to increase a heating area of the heating track 1321. The two connection electrodes 1324 and 1325 are in the shape of cylinder, and the two end surface electrodes 1322 and 1323 are in the shape of annular sheet. The upper end of the connection electrode 1324 is connected to the end surface electrode 1322, and the lower end is connected to the upper ends of the three heating tracks 1321. The lower end of the connection electrode 1325 is connected to the end surface electrode 1323, and the upper end is connected to the lower ends of the three heating tracks 1321.

It may be understood that, in another embodiment, one, two, three or more heating tracks 1321 may be provided, and/or the heating track 1321 may extend in a linear manner.

The base 16 is arranged at the lower end of the shell 11 and blocks the lower end of the liquid storage cavity 110. In some embodiments, both the base 16 and the vent tube 12 may be electrically conductive. The end surface electrode 1322 may be directly or indirectly electrically connected to the vent tube 12, and then electrically connected to the base 16. The electrode column 14 is arranged to penetrate through the base 16 along the longitudinal direction and is electrically insulated from the base 16. The end surface electrode 1323 is directly or indirectly electrically connected to the electrode column 14.

In some embodiments, the base 16 may be integrally formed with a metal material, and may be fixed in the shell 11 in a riveting manner or the like. The base 16 may include a base portion 161, an embedding portion 162 extending upward from the upper end surface of the base portion 161, and a docking portion 163 extending downward from the lower end surface of the base portion 161. The base portion 161 may be in the shape of cylinder, the upper end surface of the base portion 161 may abut against the lower end surface of the shell 11, and the outer diameter of the base portion 161 may be equal to the outer diameter of the lower end of the shell 11. The docking portion 163 may be in the shape of cylinder, and the outer wall surface of the docking portion 163 is provided with a threaded structure for a threaded connection to the power supply device 200. The outer diameter of the docking portion 163 may be less than the outer diameter of the base portion 161.

The embedding portion 162 may be in the shape of cylinder and embedded in the lower portion of the shell 11, and at least partial outer peripheral surface of the embedding portion 162 is in a sealing fit with the inner wall surface of the shell 11 to seal and block the lower end of the liquid storage cavity 110. Specifically, in this embodiment, the embedding portion 162 may include a body portion 1621 and a seal protruding stage 1622 extending outward from the body portion 1621. The outer wall surface of the body portion 1621 may be in a clearance fit with the inner wall surface of the shell 11, and the body portion 1621 has a long length along the axial direction, which can reduce assembly force required when the base 16 is mounted into the shell 11. The seal protruding stage 1622 is in an interference fit with the inner wall surface of the shell 11, and a sealing effect is enhanced through the interference fit. The axial length of the seal protruding stage 1622 is short, which can reduce the assembly force required when the base 16 is mounted into the shell 11 while ensuring sealability. In addition, the seal protruding stage 1622 may be located on the top of the body portion 1621 or arranged close to the top of the body portion 1621, so that less liquid substrate infiltrates into a space between the outer wall surface of the embedding portion 162 and the inner wall surface of the shell 11, and a leakage prevention effect is better. A guide sloping surface 1623 may further be formed at the upper end of the seal protruding stage 1622, the outer diameter of the guide sloping surface 1623 gradually decreases from bottom to top, and the outer diameter of the upper end of the guide sloping surface 1623 is less than the inner diameter of the shell 11, making it convenient to guide the seal protruding stage 1622 into the shell 11. It may be understood that, in another embodiment, the outer wall surface of the body portion 1621 may alternatively be in a transition fit with the inner wall surface of the shell 11. In some other embodiments, the seal protruding stage 1622 may alternatively be located at the middle or lower portion of the body portion 1621.

Further, the embedding portion 162 may further include a connection portion 1624 connected to the lower end of the body portion 1621. The outer wall surface of the connection portion 1624 may be in an interference fit with the inner wall surface of the shell 11, which can further improve the liquid leakage prevention effect, and can additionally fix the embedding portion 162 in the shell 11 more firmly. In addition, because the embedding portion 162 is located at an opening of the shell 11, the embedding portion 162 has less impact on the assembly force required when the base 16 is mounted into the shell 11. It may be understood that, in another embodiment, the outer wall surface of the connection portion 1624 may alternatively be in a transition fit or a clearance fit with the inner wall surface of the shell 11.

in some embodiments, a heat insulation space 1610 may further be formed on the base 16, and the heat insulation space 1610 can serve functions of heat insulation and heat preservation, to reduce heat transferred from the base 16 to the outside and reduce heat loss.

In this embodiment, the heat insulation space 1610 is an annular groove, which is formed by inward concaving the outer peripheral surface of the base portion 161 along the radial direction. Because the outer diameter of the base portion 161 is the largest, the heat insulation space 1610 can have a large volume by setting the heat insulation space 1610 on the base portion 161, which can further improve heat insulation effect and reduce heat transferred to the docking portion 163, thereby reducing heat transferred to the power supply device 200. It may be understood that, in another embodiment, the heat insulation space 1610 may alternatively be in another shape, for example, the shape of spaced petals.

In some other embodiments, the heat insulation space 1610 may alternatively be entirely or partially formed on the embedding portion 162 or the docking portion 163. In addition, the heat insulation space 1610 may further be filled with a heat insulation material to further improve the heat insulation effect.

In some embodiments, the main body 10 for liquid storage and vaporization may further include a fixing sleeve 17, the fixing sleeve 17 is in the shape of cylinder and sleeved at the lower end of the shell 11 and outside the base portion 161, which can enhance fixation between the shell 11 and the base 16, and can additionally seal the heat insulation space 1610.

The vent tube 12 may be integrally formed using a metal material, and may include a first tube section 121, a second tube section 122, and a third tube section 123 that are sequentially connected from top to bottom along the axial direction. The inner diameters and the outer diameters of the first tube section 121, the second tube section 122, and the third tube section 123 sequentially increase. The first tube section 121 has the smallest outer diameter, so that the liquid storage cavity 110 formed between the outer wall surface of the first tube section 121 and the inner wall surface of the shell 11 is provided with a large liquid storage space. The third tube section 123 is embedded in the base 16, and the outer wall surface of the third tube section 123 is in contact with the inner wall surface of the embedding portion 162 for conduction. It may be understood that, in another embodiment, the vent tube 12 and/or the base 16 may alternatively be made of a conductive or insulation material, and then coated with a conductive layer on a part required to be conductive to implement a conductive function.

The vaporization assembly 13 is accommodated in the second tube section 122 and at least a part of the third tube section 123, and the outer diameter of the liquid absorbing body 131 may be less than the inner diameter of the second tube section 122, making it convenient to mount the liquid absorbing body 131 into the second tube section 122, and preventing the liquid absorbing body 131 from cracking due to a case that the second tube section 122 excessively squeezes the liquid absorbing body 131. In another embodiment, the outer diameter of the liquid absorbing body 131 may alternatively be equal to the inner diameter of the second tube section 122. A gap is formed between the outer wall surface of the second tube section 122 and the inner wall surface of the embedding portion 162, and at least one liquid inlet 1220 is opened on the side wall of the second tube section 122, so that the liquid substrate in the liquid storage cavity 110 can flow into the liquid absorbing body 131 by sequentially passing through the gap and the at least one liquid inlet 1220. In this embodiment, a plurality of liquid inlets 1220 are provided, and the plurality of liquid inlets 1220 are evenly spaced along the circumferential direction of the second tube section 122, which is conducive to even and sufficient liquid supply to the liquid absorbing body 131.

The upper end of the second tube section 122 is provided with a conductive end surface 1221, and the conductive end surface 1221 directly or indirectly abuts against the end surface electrode 1322 for conduction. In this embodiment, the vaporization assembly 13 further includes an elastic conductive member 133, and the conductive end surface 1221 and the end surface electrode 1322 are electrically connected through the elastic conductive member 133. The elastic conductive member 133 may generate a certain elastic deformation along the axial direction of the vaporization core 130, so that the vaporization core 130 can generate certain elastic floating along the axial direction of the second tube section 122. In this way, when product consistency is poor, a reliable electrical connection is still formed between the conductive end surface 1221 and the end surface electrode 1322. Further, the vaporization assembly 13 further includes a buffer member 134 arranged between the conductive end surface 1221 and the end surface electrode 1322. The buffer member 134 may be made of an insulation elastic material such as silicone, which can prevent the porous ceramic liquid absorbing body from being crushed during mounting.

Specifically, the elastic conductive member 133 may be integrally formed by a metal material such as phosphor bronze or 316 stainless steel. The surface of the elastic conductive member 133 may further be plated with gold, silver or the like, to improve conductivity. The elastic conductive member 133 may include a main body portion 1331 and at least one elastic arm 1332 connected to the main body portion 1331. The main body portion 1331 is in the shape of annular sheet, which may be arranged between the conductive end surface 1221 and the upper end surface of the buffer member 134, and abut against the conductive end surface 1221 for conduction. A plurality of conductive bumps 1334 may further be arranged on the upper end surface of the main body portion 1331, the plurality of conductive bumps 1334 are evenly spaced along the circumferential direction of the main body portion 1331, and the main body portion 1331 is in contact with the conductive end surface 1221 through the plurality of conductive bumps 1334 for conduction. Because it is intended to generate burrs during manufacturing the sheet-shaped main body portion 1331, contact stability between the main body portion 1331 and the conductive end surface 1221 is affected. By adding the conductive bumps 1334, it can be ensured that when the product consistency is poor, a reliable electrical connection can be still realized between the main body portion 1331 and the conductive end surface 1221. In some embodiments, 2-5 conductive bumps 1334 may be provided.

The elastic arm 1332 includes a conduction portion 1335 configured to elastically abut against the end surface electrode 1322 for conduction and a connection arm 1336 connecting the conduction portion 1335 and the main body portion 1331. Preferably, a plurality of elastic arms 1332 are provided, the plurality of elastic arms 1332 are evenly spaced along the circumferential direction of the main body portion 1331, and electrical connections between the plurality of elastic arms 1332 and the end surface electrode 1322 are more reliable. In some embodiments, 2-4 elastic arms 1332 may be provided. On one hand, the widths of the elastic arms 1332 can be ensured, so that the elastic arms 1332 can be in a more stable contact with the end surface electrode 1322. On the other hand, requirements on manufacturing processes are met for manufacturing convenience. Specifically, in this embodiment, three elastic arms 1332 are provided, and three conductive bumps 1334 are provided.

In this embodiment, the connection arm 1336 is in the shape of strip and has good elasticity, which may extend obliquely downward for a certain distance from the middle of the lower end surface of the main body portion 1331. The conduction portion 1335 is in the shape of sheet, which can extend along the lateral direction from an end of the connection arm 1336 that is away from the main body portion 1331, to form a good contact with the end surface electrode 1322. The width of the connection arm 1336 may be equal to that of the conduction portion 1335, which is convenient for processing and forming. In another embodiment, the width of the connection arm 1336 may alternatively be not equal to that of the conduction portion 1335, for example, the width of the conduction portion 1335 may be greater than the width of the connection arm 1336. A connection between the connection arm 1336 and the conduction portion 1335 may be in a smooth transition through a rounded corner to avoid a sharp corner at the connection. On one hand, the sharp corner is intended to cause stress concentration, and the elastic arm 1332 is intended to be broken. On the other hand, the sharp corner is further intended to scratch the end surface electrode 1322, causing the end surface electrode 1322 to fail in circuit opening. Further, a plurality of notches 1333 may be formed on the main body portion 1331, and the plurality of notches 1333 are evenly spaced along the circumferential direction of the main body portion 1331. The elastic arm 1332 may be formed by extending downward from a side of the notch 1333 along the circumferential direction. On one hand, it is convenient to integrally form the elastic conductive member 133. On the other hand, the notch 1333 can relieve partial stress on the main body portion 1331, to avoid a case that the stress excessively concentrates at the connection between the main body portion 1331 and the elastic arm 1332.

The elastic conductive member 133 at least partially wraps the buffer member 134, and the buffer member 134 can further flexibly support the elastic conductive member 133. Specifically, the buffer member 134 is in the shape of annular sheet, a through hole 1340 is formed on the buffer member 134 along the longitudinal direction, and the through hole 1340 communicates the output channel 120 with the vaporization cavity 1310. The upper end surface of the buffer member 134 may be concaved to form a mounting groove 1341 for accommodating the main body portion 1331, making it convenient to position the elastic conductive member 133 on the buffer member 134. The mounting groove 1341 may be in the annular shape, the depth of the mounting groove 1341 may be equal to the thickness of the main body portion 1331, so that the upper end surface of the main body portion 1331 is flush with the upper end surface of the buffer member 134 when the main body portion 1331 is accommodated in the mounting groove 1341, and it can be ensured that the upper end surface of the buffer member 134 may also abut against the conductive end surface 1221 while ensuring that the upper end surface of the main body portion 1331 is in a reliable contact with the conductive end surface 1221. Corresponding to the plurality of notches 1333, a plurality of positioning protrusions 1342 are arranged on the groove bottom surface of the mounting groove 1341. The plurality of positioning protrusions 1342 are respectively embedded in the plurality of notches 1333, to realize circumferential positioning of the elastic conductive member 133 on the buffer member 134. A plurality of penetration holes 1343 are arranged through the buffer member 134 for being penetrated through by the plurality of elastic arms 1332. Further, the plurality of penetration holes 1343 may be respectively arranged on a side of each plurality positioning protrusion 1342 along the circumferential direction. The lower end surface of the buffer member 134 may further be concaved upward to form a plurality of accommodating grooves 1344 that are respectively configured to accommodate a plurality of conduction portions 1335. The depth of the accommodating groove 1344 may be equal to the thickness of the conduction portion 1335, so that the lower end surface of the conduction portion 1335 is flush with the lower end surface of the buffer member 134 when the conduction portion 1335 is accommodated in the accommodating groove 1344, and it can be ensured that the lower end surface of the buffer member 134 may also abut against the end surface electrode 1322 while ensuring that the lower end surface of the conduction portion 1335 is in a reliable contact with the end surface electrode 1322. It may be understood that, in another embodiment, the depth of the mounting groove 1341 may be alternatively greater or less than the thickness of the main body portion 1331, and/or the depth of the accommodating groove 1344 may be greater or less than the thickness of the conduction portion 1335.

It may be understood that, in another embodiment, a fixing end of the elastic arm 1332 may also be connected to the inner wall surface or outer wall surface of the main body portion 1331. In some other embodiments, the elastic conductive member 133 and the buffer member 134 may alternatively be inversely mounted, so that the main body portion 1331 abuts against the end surface electrode 1322 for conduction, and the elastic arm 1332 elastically abuts against the conductive end surface 1221 for conduction.

The upper end of the electrode column 14 is provided with a conductive end surface 1411, and the conductive end surface 1411 directly or indirectly abuts against the end surface electrode 1323 for conduction. In this embodiment, the vaporization assembly 13 further includes an elastic conductive member 135, and the conductive end surface 1411 and the end surface electrode 1323 are electrically connected through the elastic conductive member 135. The elastic conductive member 135 may generate a certain elastic deformation along the longitudinal direction, so that the vaporization core 130 can generate certain elastic floating along the longitudinal direction. In this way, when the product consistency is poor, a reliable electrical connection is still formed between the conductive end surface 1411 and the end surface electrode 1323. Further, the vaporization assembly 13 further includes a buffer member 136. The buffer member 136 may be made of an elastic insulation material such as silicone. The elastic conductive member 135 at least partially wraps the buffer member 136, and the buffer member 136 can flexibly support the elastic conductive member 135.

Specifically, the elastic conductive member 135 may be integrally formed by a metal material such as phosphor bronze or 316 stainless steel. The surface of the elastic conductive member 135 may further be plated with gold, silver or the like, to improve conductivity. The elastic conductive member 135 may include a main body portion 1351 and at least one elastic arm 1352 connected to the main body portion 1351. The main body portion 1351 is in the shape of annular sheet, which may be arranged between the end surface electrode 1323 and the upper end surface of the buffer member 136, and abut against the end surface electrode 1323 for conduction. A plurality of conductive bumps 1354 may further be arranged on the upper end surface of the main body portion 1351, the plurality of conductive bumps 1354 are evenly spaced along the circumferential direction of the main body portion 1351, and the main body portion 1351 is in contact with the end surface electrode 1323 through the plurality of conductive bumps 1354 for conduction.

Because it is intended to generate burrs during manufacturing the sheet-shaped main body portion 1351, contact stability between the main body portion 1351 and the end surface electrode 1323 is affected. By adding the conductive bumps 1354, it can be ensured that when the product consistency is poor, a reliable electrical connection can be still realized between the main body portion 1351 and the end surface electrode 1323. In some embodiments, 2-5 conductive bumps 1354 may be provided.

The elastic arm 1352 includes a conduction portion 1355 configured to elastically abut against the conductive end surface 1411 for connection and a connection arm 1356 connecting the conduction portion 1355 and the main body portion 1351. Preferably, a plurality of elastic arms 1352 are provided, the plurality of elastic arms 1352 are evenly spaced along the circumferential direction of the main body portion 1351, and electrical connections between the plurality of elastic arms 1352 and the conductive end surface 1411 are more reliable. In some embodiments, 2-4 elastic arms 1352 may be provided. On one hand, the widths of the elastic arms 1352 can be ensured, so that the elastic arms 1352 can be in a more stable contact with the conductive end surface 1411. On the other hand, requirements on manufacturing processes are met for manufacturing convenience. Specifically, in this embodiment, three elastic arms 1352 are provided, and three conductive bumps 1354 are provided.

In this embodiment, the elastic arm 1352 is substantially in a U-shaped sheet structure. The connection arm 1356 may be bent outward from an outer edge of the main body portion 1351 and then extend inward for a certain distance along the radial direction of the main body portion 1351. The conduction portion 1355 is bent downward from an end of the connection arm 1356 that is away from the main body portion 1351 and then extends outward for a certain distance along the radial direction of the main body portion 1351. The width of the connection arm 1356 may be equal to that of the conduction portion 1355, which is convenient for processing and forming. In another embodiment, the width of the connection arm 1356 may alternatively be not equal to that of the conduction portion 1355, for example, the width of the conduction portion 1355 may be greater than the width of the connection arm 1356.

The buffer member 136 may be in the shape of annular cylinder and accommodated in the third tube section 123, and a mounting hole 1360 in communication with the vaporization cavity 1310 is formed on the buffer member 136 along the longitudinal direction. The lower end of the liquid absorbing body 131 may be embedded in the mounting hole 1360, so that the liquid absorbing body 131 can be flexibly clamped and fixed, and additionally liquid leakage is prevented by a sealing fit between the outer wall surface of the liquid absorbing body 131 and the hole wall surface of the mounting hole 1360 and a sealing fit between the outer wall surface of the buffer member 136 and the inner wall surface of the third tube section 123.

The hole wall surface of the mounting hole 1360 may extend along the lateral direction to form an annular protruding edge 1361, and the annular protruding edge 1361 is arranged between the conductive end surface 1411 and the end surface electrode 1323, to prevent the porous ceramic liquid absorbing body from being crushed during mounting. In this embodiment, the main body portion 1351 abuts against the upper end surface of the annular protruding edge 1361. The elastic arm 1352 is clamped on the annular protruding edge 1361, and the upper and lower U-shaped arms of the elastic arm 1352 may respectively abut against the upper end surface and the lower end surface of the annular protruding edge 1361. The upper end of the electrode column 14 abuts against the lower end surface of the annular protruding edge 1361 through the conduction portion 1355.

It may be understood that, in another embodiment, the elastic conductive member 135 may alternatively be inversely mounted, so that the main body portion 1351 abuts against the conductive end surface 1411 for conduction, and the elastic arm 1352 elastically abuts against the end surface electrode 1323 for conduction.

The electrode column 14 may be insulated from and hermetically connected to base 16 through an insulation sleeve 15. Specifically, the electrode column 14 may include a first column body 141 and a second column body 142 connected to the lower end of the first column body 141, and the outer diameter of the first column body 141 is greater than the outer diameter of the second column body 142. In another embodiment, the outer diameter of the first column body 141 may alternatively be equal to or less than the outer diameter of the second column body 142. The insulation sleeve 15 may be made of silicone or a plastic cement material. The insulation sleeve 15 is arranged in the docking portion 163 along the longitudinal direction. The second column body 142 is arranged in the insulation sleeve 15 along the longitudinal direction, and the lower end surface of the first column body 141 may abut against the upper end surface of the insulation sleeve 15. In some embodiments, the insulation sleeve 15 may be in the shape of a ring with an opening on one side, a through hole 150 is formed through the insulation sleeve 15 along the longitudinal direction, and the electrode column 14 is arranged to penetrate through the through hole 150. A breaking groove 151 is formed on a side of the insulation sleeve 15 along the circumferential direction, and the breaking groove 151 runs through the upper side and lower side of the insulation sleeve 15, making it convenient to assemble the electrode column 14 into the insulation sleeve 15.

In some embodiments, the middle of the top surface of the electrode column 14 may extend downward to form a vent hole 140, and the upper end of the vent hole 140 is in communication with the vaporization cavity 1310. The lower end of the vent hole 140 is provided with a bottom wall 143, and the bottom wall 143 blocks the lower end of the vent hole 140, to prevent the leaking liquid from leaking to the outside. At least one air inlet 1412 is further formed on the side wall of the first column body 141, and at least one air inlet hole 1630 may further be opened on the side wall of the upper portion of the docking portion 163 that is not provided with a threaded structure. An annular vent gap 144 is formed between the outer wall surface of the first column body 141 and the inner wall surface of the base 16, and the outside air can enter the vent hole 140 by sequentially passing through the air inlet hole 1630, the vent gap 144, and the air inlet 1412. In this embodiment, a plurality of air inlets 1412 and air inlet holes 1630 are provided, the plurality of air inlets 1412 are evenly spaced along the circumferential direction of the first column body 141, and the plurality of air inlet holes 1630 are evenly spaced along the circumferential direction of the docking portion 163.

In some embodiments, at least one vent passage 152 may further be formed on the insulation sleeve 15, and the at least one vent passage 152 communicates the vent gap 144 with the outside. In one embodiment, the vent passage 152 may be configured for air intake, that is, for the outside air to enter the vent gap 144. In this case, the base 16 may or may not be provided with the air inlet holes 1630. In another embodiment, the vent passage 152 may be configured to communicate the vent gap 144 with an airflow sensor in the power supply device 200, so that the power supply device 200 can be enabled through the airflow sensor when inhaling, to supply power to the vaporizer 100.

In this embodiment, a plurality of vent passages 152 are provided and evenly spaced along the circumferential direction of the insulation sleeve 15. Each vent passage 152 includes a vent opening 1521 formed on the upper end surface of the insulation sleeve 15 and a vent groove 1522 that is in communication with the vent opening 1521 and formed on the inner wall surface of the insulation sleeve 15 along the longitudinal direction. It may be understood that, in another embodiment, the vent passage 152 may alternatively be formed on the outer wall surface of the insulation sleeve 15.

In some embodiments, a ventilation channel is further formed on the buffer member 136, and the ventilation channel is separately in communication with the vent gap 144 and the liquid inlet 1220, to communicate the liquid storage cavity 110 with the outside for balancing pressure in the liquid storage cavity 110, thereby solving a problem that the liquid cannot be stably released due to an excessively large negative pressure in the liquid storage cavity 110. Specifically, in this embodiment, the bottom surface of the buffer member 136 is concaved upward to form at least one ventilation inlet 1362 through the inner side and outer side of the buffer member 136, at least one first ventilation groove 1363 in communication with the at least one ventilation inlet 1362 is formed on the lower portion of the outer side wall of the buffer member 136, at least one second ventilation groove 1365 is formed on the upper portion of the outer side wall of the buffer member 136, and a communication groove 1364 communicating the at least one first ventilation groove 1363 and the at least one second ventilation groove 1365 is formed on the middle of the outer side wall of the buffer member 136. The ventilation inlet 1362, the first ventilation groove 1363, the communication groove 1364, and the second ventilation groove 1365 are sequentially in communication to form the ventilation channel. The cross-sectional area of the ventilation channel is small enough to generate capillary force in a use state, which can reduce liquid leakage.

Further, in this embodiment, a plurality of ventilation inlets 1362 and first ventilation grooves 1363 are provided and evenly spaced along the circumferential direction of the buffer member 136. The plurality of ventilation inlets 1362 are in communication with the plurality of first ventilation grooves 1363 in a one-to-one correspondence. One communication groove 1364 is provided and the communication groove 1364 is in the annular shape. A plurality of second ventilation grooves 1365 are provided, and the plurality of second ventilation grooves 1365 and the plurality of first ventilation grooves 1363 are arranged in a staggered manner along the circumferential direction, which is conducive to extending the path of the ventilation channel, so that liquid leakage can be further alleviated, and additionally more leaking liquid can be stored.

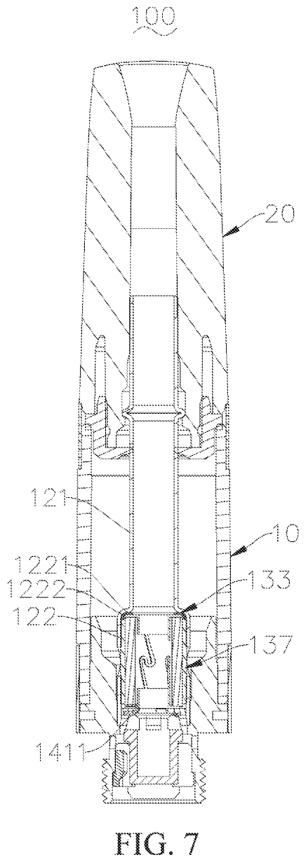

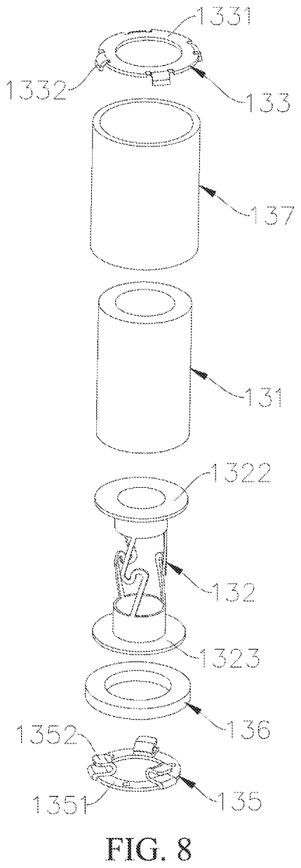

FIG. 7 and FIG. 8 show a vaporizer 100 in the second embodiment of the present application. Different from the foregoing first embodiment, a vaporization assembly 13 in this embodiment further includes a liquid guide cotton 137 sleeved outside the liquid absorbing body 131. In addition, the vaporization assembly 13 in this embodiment does not include a buffer member 134.

Specifically, in this embodiment, a vent tube 12 merely includes a first tube section 121 and a second tube section 122 connected to the lower end of the first tube section 121. Both the inner diameter and the outer diameter of first tube section 121 are less than the inner diameter and the outer diameter of second tube section 122. The vaporization assembly 13 is accommodated in the second tube section 122. The inner diameter of the second tube section 122 may be slightly less than the outer diameter of the liquid guide cotton 137, so that the second tube section 122 can tightly clamp the liquid guide cotton 137, the vaporization assembly 13 can be fixed, and additionally the liquid leakage can be reduced through sealing. It may be understood that, in another embodiment, the inner diameter of the second tube section 122 may alternatively be equal to or greater than the outer diameter of the liquid guide cotton 137.

An elastic conductive member 133 includes a main body portion 1331 and a plurality of elastic arms 1332 connected to an outer edge of the main body portion 1331. The main body portion 1331 is in the shape of annular sheet. The plurality of elastic arms 1332 may extend obliquely downward and outward from the outer edge of the main body portion 1331, and may be evenly spaced along the circumferential direction of the main body portion 1331. The upper end surface and the lower end surface of the main body portion 1331 respectively abut against a conductive end surface 1221 and an end surface electrode 1322 for conduction. The conductive end surface 1221 and the inner circumferential surface of the second tube section 122 are in a transition connection through an arc surface 1222, the plurality of elastic arms 1332 may be in the shape of arc sheet, and the upper surfaces of the plurality of elastic arms 1332 may further elastically abut against the arc surface 1222.

The buffer member 136 is in the shape of annular sheet. The buffer member 136 is arranged between a conductive end surface 1411 and an end surface electrode 1323, and the elastic arms 1352 are buckled on the buffer member 136 from the inner side of the buffer member 136. The elastic conductive member 135 in this embodiment has the same structure as that in the foregoing first embodiment, but is mounted in an inverse manner, that is, the main body portion 1351 abuts against the conductive end surface 1411 for conduction, and the elastic arm 1352 elastically abuts against the end surface electrode 1323 for conduction, which can better realize the electrical connection.

It may be understood that the foregoing technical features can be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporizer, comprising:
a vent tube comprising a conductive end surface;
a vaporization core accommodated in the vent tube, the vaporization core comprising an end surface electrode; and
an elastic conductive member accommodated in the vent tube, the elastic conductive member being arranged between the conductive end surface and the end surface electrode, and abutting against the conductive end surface and the end surface electrode.

2. The vaporizer of claim 1, wherein the vaporization core comprises a porous ceramic and at least one heating track in contact with the porous ceramic, and
wherein the end surface electrode is arranged on an end surface of one end of the porous ceramic close to the conductive end surface, and is connected to one end of the at least one heating track.

3. The vaporizer of claim 2, wherein the porous ceramic is in a shape of a cylinder, and the at least one heating track is arranged on an inner wall surface of the porous ceramic.

4. The vaporizer of claim 1, wherein the vent tube comprises a first tube section and a second tube section connected to one end of the first tube section,
wherein the vaporization core is accommodated in the second tube section, and
wherein an end surface of one end of the second tube section close to the first tube section forms the conductive end surface.

5. The vaporizer of claim 4, wherein an inner diameter and an outer diameter of the second tube section are respectively greater than an inner diameter and an outer diameter of the first tube section.

6. The vaporizer of claim 4, wherein the elastic conductive member comprises a main body portion,
wherein the main body portion is in a shape of an annular sheet and is arranged between the conductive end surface and the end surface electrode, and
wherein end surfaces of two ends of the main body portion respectively abut against the conductive end surface and the end surface electrode.

7. The vaporizer of claim 6, wherein the elastic conductive member comprises at least two elastic arms connected to the main body portion, and
wherein the at least two elastic arms are evenly spaced along a circumferential direction of the main body portion.

8. The vaporizer of claim 7, wherein the at least two elastic arms are integrally connected to an outer edge of the main body portion.

9. The vaporizer of claim 8, wherein the conductive end surface and an inner wall surface of the second tube section are in a transition connection through an arc surface,
wherein the at least two elastic arms are in a shape of arc sheet, and
wherein the at least two elastic arms elastically abut against the arc surface.

10. The vaporizer of claim 1, wherein the elastic conductive member comprises a main body portion and at least one elastic arm connected to the main body portion,
wherein the main body portion abuts against one of the conductive end surface and the end surface electrode, and
wherein the at least one elastic arm elastically abuts against an other of the conductive end surface and the end surface electrode.

11. The vaporizer of claim 1, further comprising:
a base,
wherein one end of the vent tube is embedded in the base and is in contact with the base.

12. An electronic vaporization device, comprising:
the vaporizer of claim 1.
